(19) United States
(12) Patent Application Publication
(10) Pub. No.: US 2014/0372447 A1
(43) Pub. Date: Dec. 18, 2014

(54) KNOWLEDGE INDEX SYSTEM AND METHOD OF PROVIDING KNOWLEDGE INDEX

(71) Applicant: ELECTRONICS AND TELECOMMUNICATIONS RESEARCH INSTITUTE, Daejeon (KR)

(72) Inventor: Jae Sook CHEONG, Daejeon (KR)

(73) Assignee: ELECTRONICS AND TELECOMMUNICATIONS RESEARCH INSTITUTE, Daejeon (KR)

(21) Appl. No.: 14/208,583

(22) Filed: Mar. 13, 2014

(30) Foreign Application Priority Data
Jun. 12, 2013 (KR) 10-2013-0067382

(51) Int. Cl. G06F 17/30

(52) U.S. Cl. CPC G06F 17/30952
USPC 707/741

(57) ABSTRACT

A knowledge index system and a method of providing a knowledge index are provided. The knowledge index system includes: a knowledge graph storage unit that includes a plurality of nodes representing a core word or a subject word about knowledge of a specific field and an edge representing an association relationship between the plurality of nodes with a line, and that stores a knowledge index representing a structure of the knowledge field in a graph form having a cycle in which more than one path may exist between any pair of nodes by displaying a related degree between two nodes at the edge; a data storage unit that stores data constituting the knowledge index; and a display unit that outputs a knowledge index of the graph form on a screen.

### CROSS-REFERENCE TO RELATED APPLICATION

This application claims priority to and the benefit of Korean Patent Application No. 10-2013-0067382 filed in the Korean Intellectual Property Office on Jun. 12, 2013, the entire contents of which are incorporated herein by reference.

### BACKGROUND OF THE INVENTION

(a) Field of the Invention

The present invention relates to a knowledge index system and a method of providing a knowledge index. More particularly, the present invention relates to a knowledge index system and a method of providing a knowledge index that searches for a subject and a concept about knowledge of a field in which a learner is to study and an association structure between such a subject and a concept, and that helps the learner to efficiency and effectively learn a structure of the knowledge.

(b) Description of the Related Art

Most knowledge has been transferred in a form of a “story” until now. The story has been expressed through a string that is used for a book, a motion picture, a voice, a chart, a graph, a picture, and a drawing. Among them, knowledge of an absolutely large quantity has been transferred in a form of a string, i.e., a document.

In many cases, when people are going to learn any subject of knowledge, they want to review entire core words and relationships thereof rather than detailed contents of knowledge of a field thereof. This is because people do not know a search word related to a question to specifically search for. When people have a kind of index for entire contents, even if the index provides an outline, the index makes it far easier to input detailed contents to enter later. Such an “index” is referred to as an “index of knowledge”.

Until now, in a book or a document, a table of contents has performed a function of an index of knowledge, and in a motion picture, a table of contents has performed a function of an index of knowledge. Such tables of contents generally have a tree form. A relationship between core words and subject words of any one field cannot be appropriately expressed in a tree structure such as a table of contents of a general book. This is because there are many cases in which one subject word is related to another subject word. In a book, such a relationship is described somewhere, and a learner should understand a description about the relationship and form the relationship in the learner's head.

As a method of forming knowledge in a structure, several methods such as a mind map, a concept map, and a knowledge map are suggested. However, such methods are used for representing a relationship between core words in detailed knowledge instead of performing a function of an index of knowledge.

Linking open data (LOD) that is used in semantic web technology uses two nodes and a triplet that connects a relationship therebetween with an edge. This is a method of representing detailed knowledge that may be represented with a sentence, as described above, and is very awkward in performing a function of an index of knowledge that may represent several random relationships.

A method of performing a function of an index of knowledge of a field includes a topic map. However, an edge (referred to as an “association”) that represents the relationship in the topic map does not have a method of representing a strong level of a relation degree.

Further, a topic map models and shows topics with a graph, but when a node number of an entire graph is very large, the topic map simplifies and shows the graph so that a user easily recognizes and cannot be extended as needed.

### SUMMARY OF THE INVENTION

The present invention has been made in an effort to provide a knowledge index system and a method of providing a knowledge index having advantages of effectively expressing, adjusting, and extending key words or key phrase_which is a frame of knowledge, and a relationship therebetween, through media for books or lectures, etc., to transfer knowledge.

An exemplary embodiment of the present invention provides a knowledge index system. The knowledge index system includes: a knowledge graph storage unit that includes a plurality of nodes representing a core word or a subject word about a knowledge field and an edge representing an association relationship between the plurality of nodes with a line, and that stores a knowledge index representing a structure of the knowledge field in a graph form having a cycle in which more than one path may exist for a given pair of nodes by displaying a related degree between two nodes at the edge; a data storage unit that stores data constituting the knowledge index; and a display unit that outputs a knowledge index of the graph form on a screen.

The knowledge index system may further include a related degree calculator that calculates the related degree according to a previously defined reference and that displays the related degree at the edge.

The knowledge index system may further include an input unit with which a user can input the previously defined reference,

wherein the related degree calculator may calculate the related degree according to the input previously defined reference or a preset previously defined reference.

The knowledge index system may further include a writing function unit that provides a writing interface with which a user can generate, adjust, and delete a node or an edge constituting a knowledge index, and that stores a knowledge index that is generated based on a node or an edge that is input through the writing interface at the knowledge graph storage unit.

The knowledge index system may further include a navigation unit that rearranges a structure of a knowledge index that is viewed on a screen whenever following nodes constituting a knowledge index are displayed on the screen based on a presently selected node.

The knowledge index system may further include a semantic processor that groups a plurality of nodes having a similar meaning into one node and that sequentially enlarges or reduces displays of adjacent nodes based on a center node among grouped nodes.

The knowledge index system may further include a bookmarking processor that selects and separately displays or stores a node or an edge that a user indicates among a plurality of nodes and a plurality of edges constituting a graph of the knowledge index.

The knowledge index system may further include a search unit that selects a node and an edge that are stored at the knowledge graph storage unit based on a search range and a search word according to a user input and that outputs a knowledge index including the selected node and edge on a screen.

Another embodiment of the present invention provides a method of providing a knowledge index. The method in which an electronic device-based knowledge index system provides a knowledge index includes: generating a plurality of nodes representing a core word or a subject word about knowledge of a specific field; forming an edge representing an association relationship between the plurality of nodes with a line; calculating a related degree between the two nodes; and displaying a knowledge index including the plurality of nodes and the edge in which the related degree is displayed on a screen in a cycle graph form in which more than one path may exist for a given pair of nodes.

The calculating of a related degree may include calculating the related degree according to the input previously defined reference or preset previously defined reference.

The displaying of a knowledge index may include displaying an entire graph of a knowledge index of a specific field.

The method may further include, after the displaying of a knowledge index: grouping a plurality of nodes having a similar meaning into one node according to a user input and sequentially enlarging or reducing displays of adjacent nodes based on a center node among the grouped nodes; selecting and separately displaying or storing a node or an edge that a user indicates among a plurality of nodes and a plurality of edges constituting a graph of the knowledge index; selecting a node and an edge that is stored at the knowledge graph storage unit based on a search range and a search word according to a user input and outputting a knowledge index including the selected node and edge on a screen; and rearranging a structure of a knowledge index that is viewed on the screen whenever following nodes constituting a knowledge index that is displayed on the screen based on a presently selected node.

The method may further include: providing a writing interface with which a user can generate, adjust, and delete a node or an edge constituting a knowledge index; and generating a knowledge index including a node or an edge that is input through the writing interface.

According to an exemplary embodiment of the present invention, a structure of concepts forming knowledge can be effectively transferred, and a learner can learn an entire concept structure in a short time. The learner can also perform efficient study and discussion by helping communication between learners or between the learner and a teacher according to a desired level and subject, and thus sharing of knowledge can be efficiently and effectively performed. Thereby, instead of studying only a theory by sitting for a long time, as time and opportunity of experience of applying a principle and knowledge increase, study can be deepened.

### BRIEF DESCRIPTION OF THE DRAWINGS

FIG. 1 is a block diagram illustrating a configuration of a knowledge index system according to an exemplary embodiment of the present invention.

FIG. 2 is a diagram illustrating a knowledge index according to an exemplary embodiment of the present invention.

FIG. 3 is a diagram illustrating a knowledge index according to an exemplary embodiment of the present invention.

FIG. 4 is a diagram illustrating semantic zoom-in and semantic zoom-out according to an exemplary embodiment of the present invention.

FIG. 5 is a diagram illustrating semantic zoom-in and semantic zoom-out according to another exemplary embodiment of the present invention.

FIG. 6 is a diagram illustrating semantic zoom-in and semantic zoom-out according to another exemplary embodiment of the present invention.

FIG. 7 is a flowchart illustrating a method of providing a knowledge index according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a knowledge index system and a method of providing a knowledge index according to an exemplary embodiment of the present invention will be described in detail with reference to the drawings.

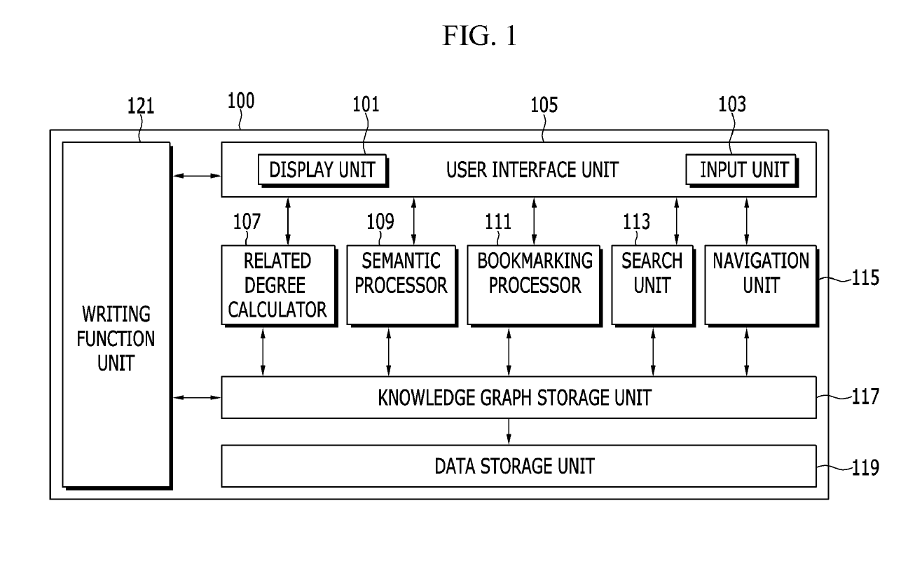

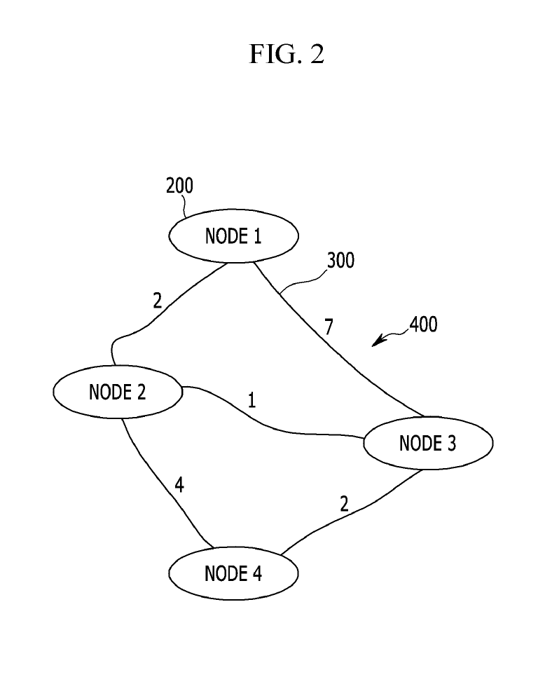

FIG. 1 is a block diagram illustrating a configuration of a knowledge index system according to an exemplary embodiment of the present invention, and FIG. 2 is a diagram illustrating a knowledge index according to an exemplary embodiment of the present invention.

Referring to FIG. 1, a knowledge index system 100 is an electronic device and may include a server device that is connected to a plurality of terminal apparatuses through a network or a terminal device in which a personal computer (PC)-based operating system is mounted.

The knowledge index system 100 provides a knowledge index that forms knowledge in a structure. That is, the knowledge index system 100 provides a graphical interface that can represent an association relationship between subjects and core concepts of knowledge of a specific field in a graph form through a knowledge index, and that can search for and adjust the association relationship between subjects and core concepts of knowledge of a specific field.

Here, a knowledge index represents a subject word or a core word about knowledge of a specific field and an association relationship between concepts with a graph. In this case, a specific field is various knowledge fields including an academic field, a job field, and a fashion field. Further, a subject word or a core word may be a keyword about corresponding knowledge.

In this case, a knowledge index according to an exemplary embodiment of the present invention has a structured form that is shown in FIG. 2.

Referring to FIG. 2, the knowledge index includes a node 200, an edge 300, and a related degree 400.

The node 200 indicates a subject word, a core word, a string, a drawing, and a motion picture itself about knowledge of a specific field.

Further, the node 200 has a position value of data and a string value. In this case, the string includes a key word, a subject word, and a core word about knowledge of a specific field. Further, data includes a document, a motion picture, a drawing, and a media file for additionally describing a string. The position value of data represents a storage path of such data. Here, the data includes computer data and Internet data, and is stored at a data storage unit 119 to be described later. When the data is computer data, a position value of the data is a computer storage position value. When the data is Internet data, a position value of the data is an Internet URL.

A relationship between such nodes 200 is represented with a line, i.e., an edge 300 between the nodes 200. The edge 300 is a line representing a logical relationship or an association relationship between the nodes 200. That is, the edge 300 may represent a logical relationship in which one node 200 is a superordinate concept or a subordinate concept of another node 200, an association relationship based on relation or association by any concept, and all kinds of relationships that a learner wants to relate.

Further, in the edge 300, the related degree 400 representing a related degree between two nodes 200 is displayed with the number. In this case, the related degree 400 may be set by a reference of Table 1.

TABLE 1

| Number | Description |
|---|---|
| No. 1 | When the number of files that any two topics share is many, |
| No. 2 | When a user indicates that any two topics are related, |
| No. 3 | Upon searching, when including any two topics together, |
| No. 4 | In addition, when any two topics appear together within a series |
| | of actions having one subject, |

That is, the related degree 400 may be set to be higher or lower according to the number of entry times and a level corresponding to an item of Table 1.

In this way, a knowledge index is a graph form that allows a cycle; it is not a tree structure. In a tree structure, only one path exists between any pair of nodes 200. However, in a graph that allows a cycle, more than one path may exist between two random nodes 200. For example, in a path between the node 1 (100) and the node 4 (100), two paths of node 1→node 2→node 4 and node 1→node 3→node 4 exist.

Referring again to FIG. 1, the knowledge index system 100 includes a user interface unit 105 including a display unit 101 and an input unit 103, a related degree calculator 107, a semantic processor 109, a bookmarking processor 111, a search unit 113, a navigation unit 115, a knowledge graph storage unit 117, a data storage unit 119, and a writing function unit 121.

The user interface unit 105 is a means for providing an interface environment for giving and receiving a command between the knowledge index system 100 and a user.

In this case, the display unit 101 outputs a knowledge index that is represented with a graph, i.e., a knowledge index of FIG. 2, on a screen.

The display unit 101 outputs a knowledge index according to operation of the related degree calculator 107, the semantic processor 109, the bookmarking processor 111, the search unit 113, the navigation unit 115, and the writing function unit 121 on a screen.

The input unit 103 is a means that enables a user to input a command word and an input word including a knowledge search word, and bookmarking a setting. The input unit 103 outputs input data to the related degree calculator 107, the semantic processor 109, the bookmarking processor 111, the search unit 113, the navigation unit 115, and the writing function unit 121.

The related degree calculator 107 calculates a related degree between the nodes 200 with one method of manual, automatic, and semiautomatic, and displays the related degree at an edge between the nodes 200.

In this case, the related degree calculator 107 may calculate a related degree between the nodes 200 according to a reference that a user manually sets through the input unit 103.

Further, the related degree calculator 107 may calculate a related degree between the nodes 200 according to an automatically or semi-automatically set reference in consideration of various factors including a search frequency and a visit frequency.

For example, as described in Table 1, the related degree calculator 107 may calculate a related degree between the nodes 200 with a preset value according to whether a previously defined condition is satisfied.

The semantic processor 109 performs a function of viewing to know a present position of a random node 200 in an entire structure of a knowledge index of a specific knowledge field. That is, a plurality of nodes 200 having a similar meaning are grouped into one node 200, and adjacent nodes are sequentially enlarged or reduced displayed based on a center node of the grouped nodes 200.

In this case, a function of enabling to know a present position in an entire structure may be provided using a small window and a pop-up window that are output to one portion of a present window, and using a mechanism that can be easily approached and activated.

The semantic processor 109 performs semantic zoom-in and semantic zoom-out.

Semantic zoom-in and semantic zoom-out provide a function of adjusting and viewing a posture degree of a knowledge index on one screen so that a user may easily recognize it.

In this case, the semantic processor 109 simplifies a graph with a method of combining and representing several nodes 200 that are connected with the edges 300 and nodes 200 forming one connection body with one node 200 in a sub-graph representing an entire graph or a portion of an entire graph forming a knowledge index. Here, the nodes 200 forming one connection body are referred to as a “connected component” according to graph theory.

Graph simplication of such a method may be recursively applied even within a subgraph that is combined with one node.

In this case, when combining several nodes 200 that are connected with the edges 300 and nodes 200 forming one connection body, one group is meaningfully formed by combining, and combining is referred to as semantic zoom-in and semantic zoom-out.

Here, a “meaning” to be a reference for combining different nodes into one node is a meaning that a learner can generally understand within a context of knowledge. A user or a writer may directly make such a meaningful combination. Further, a graph may be automatically or semi-automatically simplified through an algorithm using a related degree or other factors to be appropriate for a desired object.

The bookmarking processor 111 provides a bookmarking function about a knowledge index according to a user request that is transferred through the input unit 103. That is, among a plurality of nodes and a plurality of edges constituting a graph of a knowledge index, a node or an edge that a user designates is selected and separately displayed or stored.

Here, a bookmarking function is a function of selecting, displaying, and storing a desired node 200 or edge 300 among an entire graph of a knowledge index. That is, a bookmarking function is a function of displaying the node 200 or the edge 300 that a user wants and of enabling the user to view only the node 200 or the edge 300 later. Such a bookmarking function may be viewed in a list or in both a list and a picture. Alternatively, in an entire graph of a knowledge index, the specific node 200 or edge 300 may be displayed with different colors.

The search unit 113 transfers a search word that is transferred through the input unit 103 to the knowledge graph storage unit 117 that stores a graph of a knowledge index, i.e., a knowledge graph. The search unit 113 receives the return of the node 200 or the edge 300 including a search word and outputs the node 200 or the edge 300 to the display unit 101. That is, the search unit 113 selects a node and an edge that is stored at the knowledge graph storage unit 117 based on a search range and a search word according to a user input, and outputs a knowledge index including the selected node and edge on a screen.

In this case, a search range according to a user input may be set to an entire node, an entire edge, a partial graph, or an entire graph.

Further, when some of an entire graph is designated as a search range, a method in which some graph in the entire graph is graphically displayed according to a user input may be used.

The search unit 113 may provide a search result according to a search word in a list of the found nodes 200 or edge 300, or may provide a search result according to a search word by combining two of a list and a drawing. Here, the drawing has a graph form. Alternatively, the node 200 or the edge 300 that is found in the entire graph may be displayed with different colors.

The navigation unit 115 rearranges a structure of a knowledge index that is viewed on a screen whenever following nodes 200 constituting a knowledge index that is displayed on the screen based on a presently selected node. Here, the following operation may be an operation in which a user selects the node 200 through the input unit 103.

The navigation unit 115 puts a presently noticed core word at the center and quickly rearranges a structure of a knowledge index that is viewed on a screen whenever the user follows nodes 200 of a knowledge graph. The navigation unit 115 provides a function of returning again from a present position to a designated original position while navigating. The navigation unit 115 enables adjustment of a graph while navigating, and enables knowing a present position in an entire structure. Such navigation starts from a random node 200 and is used to visit peripheral nodes along a connected edge. Because an edge reflects an association relationship, navigation is used to follow words that are associated with any one word. Even when the user does not know a search word, the user can find a desired node 200 according to an association relationship between the nodes 200 with such a method.

The knowledge graph storage unit 117 displays a related degree between two nodes at an edge, and stores a knowledge index representing a structure of a knowledge field in a cycle graph form in which more than one path may exist between any pair of nodes. That is, the knowledge graph storage unit 117 stores a graph of a knowledge index such as FIG. 2. The knowledge graph storage unit 117 outputs a corresponding knowledge graph, node, edge, and related degree according to a request of the related degree calculator 107, the semantic processor 109, the bookmarking processor 111, the search unit 113, the navigation unit 115, the knowledge graph storage unit 117, and the writing function unit 121.

The data storage unit 119 stores individual information forming a knowledge index. That is, the data storage unit 119 stores data according to a position value of data in which the node 200 has.

The writing function unit 121 provides a writing interface with which a user can generate, adjust, and delete a node or an edge constituting a knowledge index. The writing function unit 121 stores a knowledge index that is generated based on a node and an edge that is input through the writing interface at the knowledge graph storage unit 117. That is, the writing function unit 121 embodies a writing function in which the user can generate, adjust, and delete a node or an edge constituting a knowledge index by interlocking with the user interface unit 105 and the knowledge graph storage unit 117. Such a writing function may be generally automatically or semi-automatically embodied through a function in which the user directly generates, adjusts, and deletes or writes an algorithm. Here, a writing function includes addition and deletion of the node 200, connection or deletion of the nodes 200 with the edge 300, and adjustment of a node value and an edge value. That is, a user may determine correction and adjustment of any node 200 or edge 300, and correction and adjustment of any node 200 or edge 300 may be automatically determined using the algorithm.

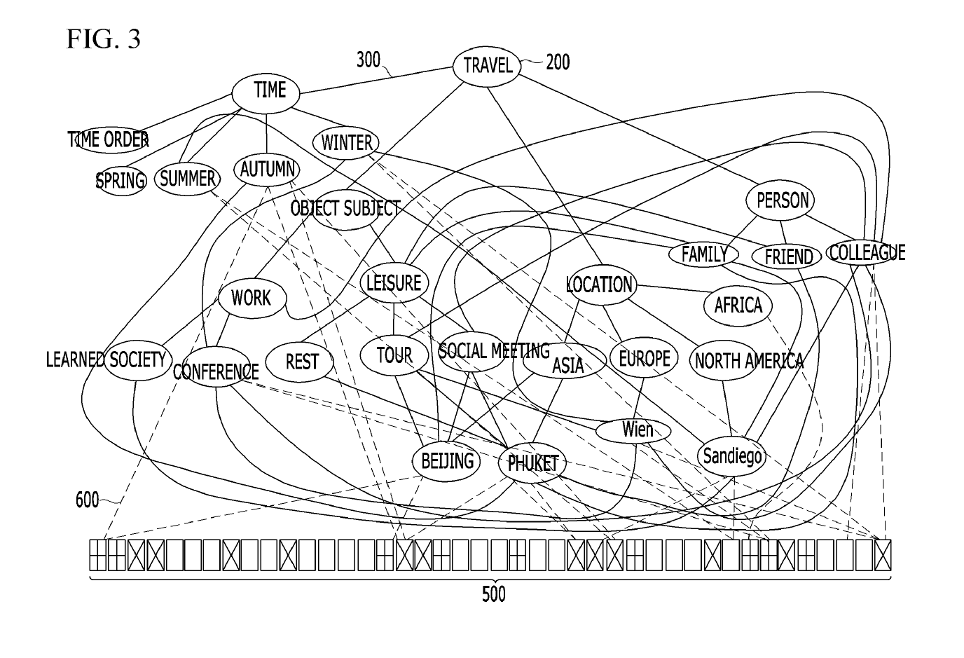

FIG. 3 is a diagram illustrating a knowledge index according to an exemplary embodiment of the present invention.

Referring to FIG. 3, linking open data (LOD) related data 500 is displayed in a lower end portion. The LOD related data 500 is sequentially arranged, but may be arranged according to the same data kind as or a different reference from that of mail, a document, a website, a phone, a FAX, a picture, and a motion picture.

In this case, FIG. 3 illustrates an entire graph of a knowledge index and illustrates a portion of a relationship between nodes and a relationship (600) between a node and data. Actual entire data are connected to one or more nodes.

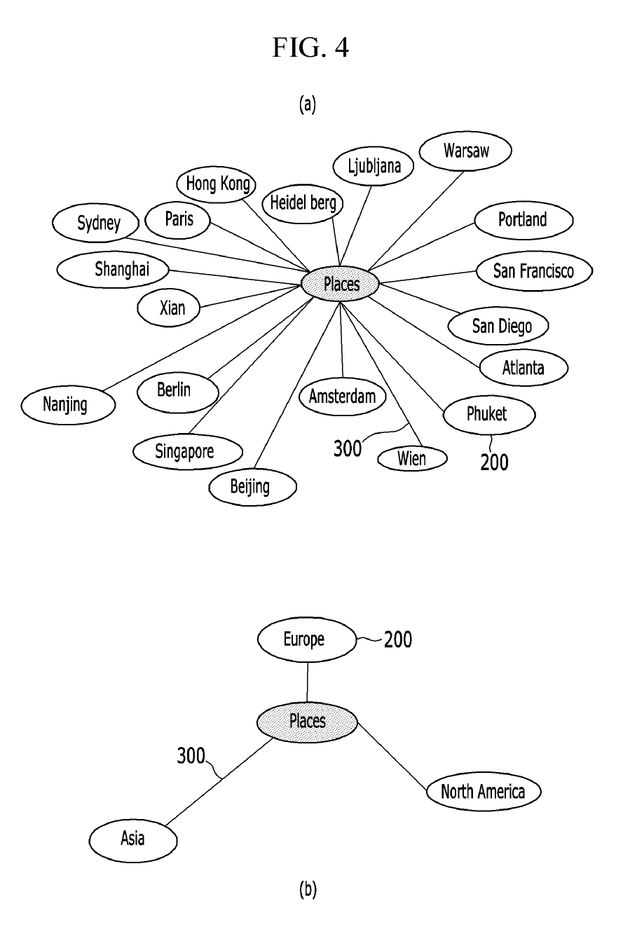

FIG. 4 is a diagram illustrating semantic zoom-in according to an exemplary embodiment of the present invention.

FIG. 4(a) illustrates an entire knowledge graph illustrating adjacent nodes and edge based on places node.

In this case, when a user input that selects a places node is transferred through the input unit 103, if the number of adjacent nodes of the places node is larger than any number that is determined in a system, as shown in FIG. 4(b), adjacent nodes are combined based on any logic and show a simplified shape.

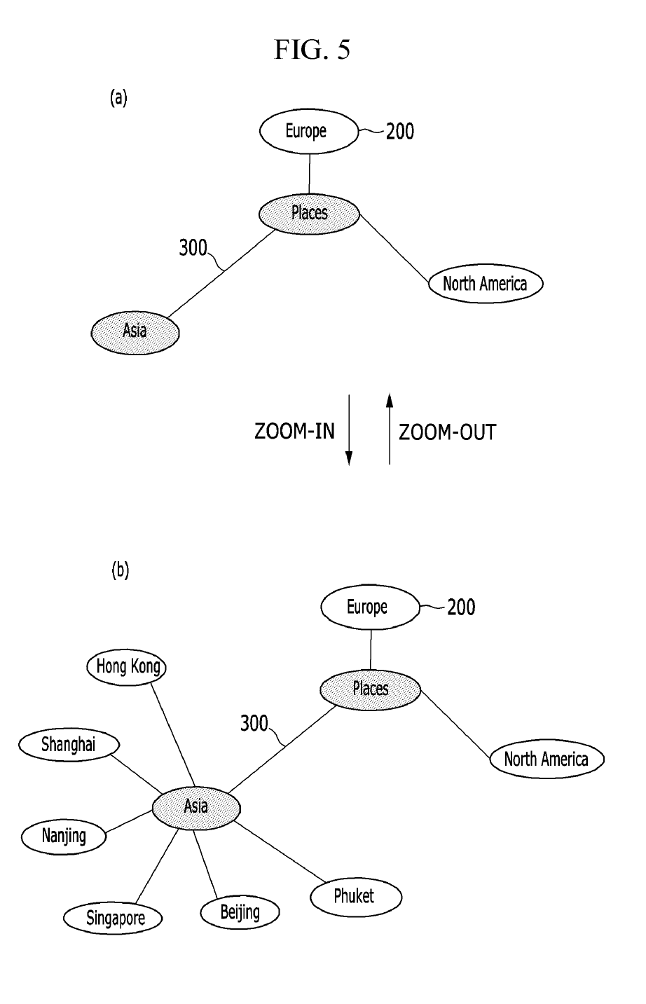

FIG. 5 is a diagram illustrating semantic zoom-in and semantic zoom-out according to another exemplary embodiment of the present invention.

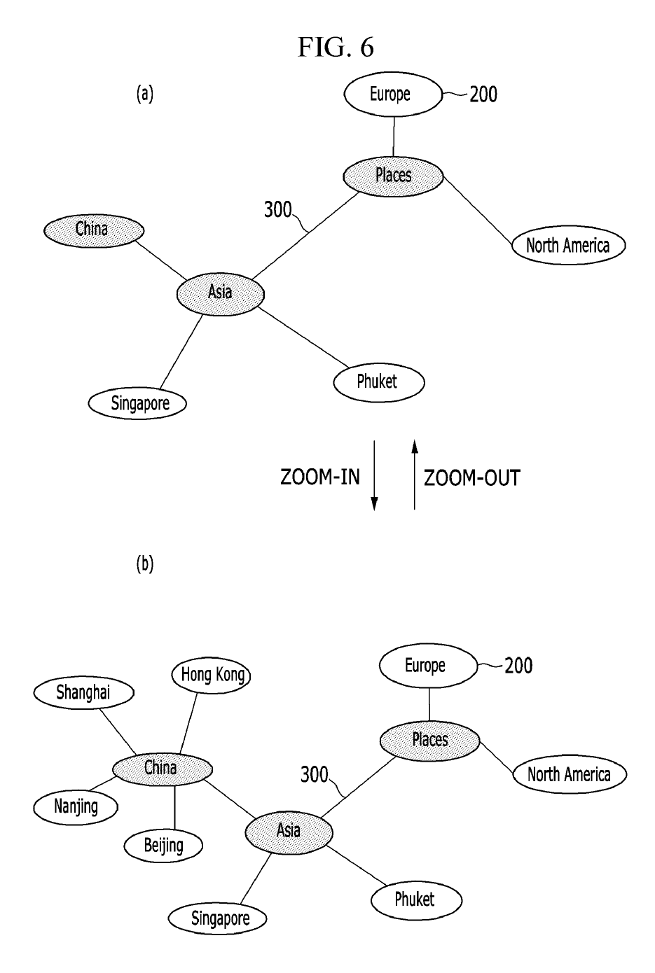

Referring to FIG. 5(a), in a state in which a semantic zoom-in function is embodied based on a places node, when an “Asia” node, which is one of adjacent nodes of the places node, is selected, the semantic processor 109 embodies a semantic zoom-in function that displays nodes that are set as one combination with the Asia node, as shown in FIG. 6(b).

Further, when a node selection position is moved from the Asia node to the places node, the semantic processor 109 embodies a semantic zoom-out function by displaying FIG. 5(a) in an opposite method.

FIG. 6 is a diagram illustrating semantic zoom-in and semantic zoom-out according to another exemplary embodiment of the present invention.

Referring to FIG. 6(a), in a state in which a semantic zoom-in function is embodied based on an Asia node, when a “China” node, which is one of adjacent nodes of the Asia node, is selected, the semantic processor 109 embodies a semantic zoom-in function that displays nodes that are set as one combination with the China node, as shown in FIG. 6(b).

When a node selection position is moved from the China node to the Asia node, the semantic processor 109 embodies a semantic zoom-out function by displaying FIG. 6(a) in an opposite method.

Hereinafter, a series of operations of a knowledge index system will be described based on the above description. In this case, the same constituent elements as those that are described in FIGS. 1 and 2 use the same reference numerals.

As described above, as shown in FIGS. 5 and 6, the semantic processor 109 groups a plurality of nodes 200 having a similar meaning into one node 200, and sequentially enlarges or reduces displays of adjacent nodes 200 based on the central node 200 among the grouped nodes 200.

Here, the central node 200 is a node that is selected in FIGS. 5 and 6.

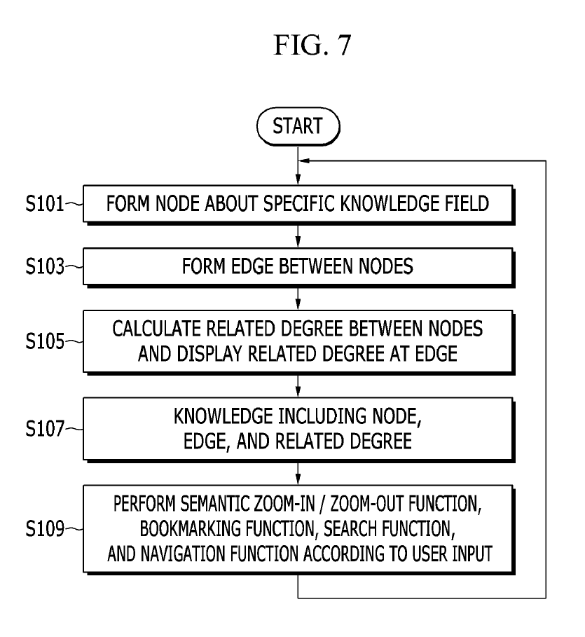

FIG. 7 is a flowchart illustrating a method of providing a knowledge index according to an exemplary embodiment of the present invention.

Referring to FIG. 7, the knowledge graph storage unit 117 forms a node 200 about a specific knowledge field (S101), and forms an edge 300 between nodes 200 according to a request of the writing function unit 121 or according to a system setting (S103). The knowledge graph storage unit 117 displays a related degree that is calculated by the related degree calculator 107 at the edge 300 (S105).

The search unit 113 transfers a search word that is transferred from the user interface unit 105 to the knowledge graph storage unit 117, and displays a graph of a knowledge index including a node 200 and an edge 300 corresponding to the search word on a screen (S107).

Thereafter, the semantic processor 109, the bookmarking processor 111, the search unit 113, and the navigation unit 115 perform the above-described semantic zoom-in/zoom-out function, bookmarking function, search function, and navigation function according to a user input that is transferred from the user interface unit 105 (S109).

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A knowledge index system, comprising:
a knowledge graph storage unit that comprises a plurality of nodes representing key words or key phrase about a knowledge field and an edge representing an association relationship between the plurality of nodes with a line, and that stores a knowledge index representing a structure of the knowledge field in a graph form having a cycle in which more than one path may exist between any pair of nodes by displaying a related degree between two nodes at the edge;
a data storage unit that stores data constituting the knowledge index; and
a display unit that outputs a knowledge index of the graph form on a screen.

2. The knowledge index system of claim 1, further comprising a related degree calculator that calculates the related degree according to a previously defined reference and that displays the related degree at the edge.

3. The knowledge index system of claim 2, further comprising an input unit through which a user can input the previously defined reference,
wherein the related degree calculator calculates the related degree according to the input previously defined reference or a preset previously defined reference.

4. The knowledge index system of claim 1, further comprising a writing function unit that provides a writing interface with which a user can generate, adjust, and delete a node or an edge constituting a knowledge index, and that stores a knowledge index that is generated based on a node or an edge that is input through the writing interface at the knowledge graph storage unit.

5. The knowledge index system of claim 1, further comprising a navigation unit that rearranges a structure of a knowledge index that is viewed on a screen whenever following nodes constituting a knowledge index are displayed on the screen based on a presently selected node.

6. The knowledge index system of claim 5, further comprising a semantic processor that groups a plurality of nodes having a similar meaning into one node and that sequentially enlarges or reduces displays of adjacent nodes based on a center node among grouped nodes.

7. The knowledge index system of claim 5, further comprising a bookmarking processor that selects and separately displays or stores a node or an edge that a user indicates among a plurality of nodes and a plurality of edges constituting a graph of the knowledge index.

8. The knowledge index system of claim 5, further comprising a search unit that selects a node and an edge that are stored at the knowledge graph storage unit based on a search range and a search word according to a user input and that outputs a knowledge index comprising the selected node and edge on a screen.

9. A method in which an electronic device-based knowledge index system provides a knowledge index, the method comprising:
generating a plurality of nodes representing a core word or a subject word about knowledge of a specific field;
forming an edge representing an association relationship between the plurality of nodes with a line;
calculating a related degree between the two nodes; and
displaying a knowledge index comprising the plurality of nodes and the edge in which the related degree is displayed on a screen in a cycle graph form in which more than one path may exist between any pair of nodes.

10. The method of claim 9, wherein the calculating of a related degree comprises calculating the degree of association according to the input previously defined reference or preset previously defined reference.

11. The method of claim 9, wherein the displaying of a knowledge index comprises displaying an entire graph of a knowledge index of a specific field,
wherein the method further comprises, after the displaying of a knowledge index:
grouping a plurality of nodes having a similar meaning into one node according to a user input and sequentially enlarging or reducing displays of adjacent nodes based on a center node among the grouped nodes;
selecting and separately displaying or storing a node or an edge that a user indicates among a plurality of nodes and a plurality of edges constituting a graph of the knowledge index;
selecting a node and an edge that is stored at the knowledge graph storage unit based on a search range and a search word according to a user input and outputting a knowledge index comprising the selected node and edge on a screen; and
rearranging a structure of a knowledge index that is viewed on the screen whenever following nodes constituting a knowledge index that is displayed on the screen based on a presently selected node.

12. The method of claim 11, further comprising:
providing a writing interface with which a user can generate, adjust, and delete a node or an edge constituting a knowledge index; and
generating a knowledge index comprising a node or an edge that is input through the writing interface.
